(19) United States
(12) Patent Application Publication
(10) Pub. No.: US 2026/0129120 A1
(43) Pub. Date: May 7, 2026

(54) AUTOMATED CHARACTERISTIC IDENTIFICATION

(71) Applicant: Express Scripts Strategic Development, Inc., St. Louis, MO (US)

(72) Inventors: Shivam Desai, Wallington, NJ (US); Mahipal Singareddy, Parsippany, NJ (US); Anirban Chowdhury, Frisco, TX (US); Paul Jerchaflie, Sparta, NJ (US); Michael Nassar, Los Angeles, CA (US); Nikhil Dinesh Yajaman, Hackensack, NJ (US); Venkata K. Potturi, Argyle, TX (US)

(21) Appl. No.: 19/382,124

(22) Filed: Nov. 6, 2025

Related U.S. Application Data
(60) Provisional application No. 63/717,626, filed on Nov. 7, 2024.

(51) Int. Cl. H04M 3/42; G06F 11/07; H04L 51/02

(52) U.S. Cl. CPC H04M 3/42042; G06F 11/0793; H04L 51/02

(57) ABSTRACT

Apparatuses, systems, and methods relate to technology to classify a communication session into a first category of a plurality of categories. The technology identifies a selected model from a plurality of models based on the communication session being classified into the first category, where the selected model includes neurons that include adjustable weight parameters, and the selected model is configured to process communication data of the communication session with the neurons. The weight parameters modify values of the neurons. The technology determines, with the selected model, a characteristic of the communication session.

### CROSS-REFERENCE TO RELATED APPLICATIONS

The present application claims the benefit of priority to U.S. Patent Application No. 63/717,626 (filed on Nov. 7, 2024), which is hereby incorporated by reference in its entirety.

### TECHNICAL FIELD

The present disclosure relates to an enhanced electronic system to identify characteristics of a communication session. Specifically, examples herein provide a versatile and efficient tool for identifying characteristics from thousands of interactions and presenting the characteristics on a new and functionally enhanced graphical user interface. Examples facilitate the display of and the rapid placement of the characteristics within a graphical user interface that can be presented in real time.

### BACKGROUND

Telecommunications can include an electronic transmission of information over distances for different purposes. Voice telephone calls, text messaging, emailing image sharing, video teleconferences, and/or video sharing can occur over telecommunication networks. Telecommunications are used to organize computer systems into telecommunications networks. These networks themselves can be operated by computers.

### BRIEF DESCRIPTION OF THE SEVERAL VIEWS OF THE DRAWINGS

The various advantages of the embodiments of the present disclosure will become apparent to one skilled in the art by reading the following specification and appended claims, and by referencing the following drawings, in which:

FIG. 1 is a diagram of an example of a communication session analysis architecture according to an embodiment;

FIGS. 2A, 2B and 2C are graphical user interfaces that display characteristics of a communication session according to an embodiment;

FIG. 3 is an open search architecture diagram according to an embodiment;

FIG. 4 is a block diagram of an example of a computing system according to an embodiment;

FIG. 5 is a flowchart of an example of a method of determining characteristics according to an embodiment;

FIG. 6 is a block diagram of an example characteristic identification engine that may be deployed within the system of FIG. 1, according to some examples;

FIG. 7 is a functional block diagram of an example neural network that can be used for the inference engine or other functions (e.g., engines) as described herein to produce a predictive model;

FIG. 8 is a functional block diagram of an example pharmacy fulfillment device, which may be deployed within the system of FIG. 1; and

FIG. 9 is a functional block diagram of an example order processing device, which may be deployed within the system of FIG. 1.

### DETAILED DESCRIPTION

Examples relate to enhanced and automated communication session analysis processes that can determine characteristics of a telecommunication system. Doing so can facilitate electronic or mechanical granular analysis and the implementation of specific actions to enhance the effectiveness of communications. Examples are based on cutting-edge telecommunication technologies and machine learning models implemented in computing devices.

Several different communication technologies may implement remote communication. For example, electronic mail (email), video conferencing, telephony, and chat have rapidly increased in size, scope and magnitude as commensurate infrastructure has developed and due to increased demand. Remote communication is widely adopted and facilitates communication between customers and entities (e.g., companies, corporations, and the like) for example. Such communication technologies are often convenient but can suffer from imperfect implementations leading to increased length of communications, lower customer satisfaction and increased labor to remediate the imperfect implementations. Furthermore, such imperfect implementations lack actionable insight that guide future decision making. Moreover, manually identifying such issues and insight in real-time is impossible given the bulk of information. That is, it would be impossible to manually classify and identify issues among thousands of telecommunication sessions (e.g., phone, video conferencing, chats and emails), etc., as doing so would take months to analyze the volume of data for any issues, at which time the issues may no longer be present and/or are unable to be remediated.

In some cases, determining characteristics of a communication session between at least two devices including a first device of a customer and a second device of an entity may result in opportunities for remediation via future automated actions. The characteristics can indicate whether the communication session is progressing smoothly or whether the communication session is unsatisfactory (e.g., from the customer and/or the entity perspective). The characteristics can dictate future and/or current actions (e.g., intervention and/or adjustment).

For example, entities (e.g., business devices and operations partner devices) who support a digital experience for customers (e.g., via provider devices and/or patient/member devices) are constantly looking for key information, key performance indicators (KPIs) and metrics that can be used to iteratively improve the overall digital experience for the customers (e.g., patients or users). Such entities can be seeking a mechanism that not only allows the entities to capture the KPIs at a single repository, but also facilitates simple presentation (e.g., on a graphical user interface) for the entities to consume, analyze and perform action without spending significant time (e.g., thousands of hours traversing through huge sets of unorganized and unstructured data related to customer behavior). In some embodiments, KPIs can be data types or the data defined by the KPI.

Indeed, in some examples a human being is unable to accurately assess and determine the KPIs given the massive quantity of unstructured and informal data in the form of conversations and the data, including derived data, resulting from the conversations. Conversations can include audio interaction and digital (chat, text, email and the like) conversations. Furthermore, human subjectivity can significantly impact the formulation of the KPIs, meaning that such KPIs are often inconsistently determined. For example, a first reasonable person can perceive a communication to be positive in nature, while a second reasonable person could believe the opposite depending on their life experience and viewpoints. Moreover, human bias can greatly influence the KPI analysis. Consequently, human determined KPIs are inaccurate, unreliable and inconsistent as well as frequently incomplete. Examples herein solve these aforementioned problems by providing a neutral, unbiased and consistent way to evaluate and develop KPIs across a wide body of data and data types. Accordingly enhanced examples herein are significantly improved relative to previous implementations and solve several problems by machine implementation of specialized methodologies.

Thus, examples provide a method and system to analyze the communication session to determine the characteristics and present the characteristics in a meaningful way to the entities. Indeed, some examples can operate in real time to permit adjustments to the communication session in real time to obtain enhanced efficiency and better meet targets of the communication session.

For example, suppose that the communication session is a chatbot session between a customer and a chatbot. Enhanced examples herein can analyze the conversation to determine that the user is becoming agitated and/or frustrated. The chatbot parameters can be adjusted to provide empathetic outputs (e.g., I am sorry you are agitated), provide a rephrased and clearer answer, and/or directly connect the user with a human operator that replaces the chatbot in the chat. That is, parameters of a computing system related to the communication session can be adjusted in real time. In some instances, the interaction from the customer device is a recording or transcription by the customer device transmitted to the entity device.

In other examples, suppose that a telephone conversation is occurring between a company representative on an entity device and a customer on a customer device. Suppose further that the sentiment of the conversation is negative (e.g., customer and/or representative are become agitated, defensive, angry, etc.), an automatic emergency breakthrough can be scheduled and performed to connect the customer with a different customer representative (e.g., manager) to diffuse the situation and improve customer satisfaction and reduce total call length. That is, a parameter of the telephone conversation can automatically be adjusted to electronically contact a different customer representative and break into the phone call (e.g., interrupt the phone call and three-way the different customer representative into the phone call). Similarly, if the sentiment of an email exchange is negative, examples can automatically institute remediation actions and/or adjust parameters of the computing system such as by contacting and inserting a new customer representative into the exchange and removing the old customer representative, scheduling a follow-up call for a customer, etc.

In some examples, the characteristics can be compiled and displayed via a dashboard. Doing so provides new functionality that was previously unavailable. For example, numerous different forms of electronic communication (e.g., conversations, both digital and audio) exist. These electronic communications are based on several computer components including mainframe computers (e.g., a host), communications servers, and the exchange participants' computers (client). The computer components can form the electronic heart of the fully computerized electronic analysis system that receives communications and analyzes the communications. In an example, a part of the computer components can run differently trained machine implemented models on different processing circuitry.

Before implementation of the dashboard mentioned above, users would navigate through multiple dashboards (e.g., at least 3-4 different dashboards), and enter different login credentials at each dashboard to acquire relevant information. Further, users would have to read through entire transcripts of conversations to understand and determine the topic(s) and sentiment(s) on a periodic basis (e.g., weekly amounts can be over 15,000 transcripts). Doing so is inefficient and results in sub-optimal information analysis. For example, each dashboard may present different information without any connection to other information in the other dashboards, missing valuable insights as well as an overall analysis of the interactions.

Solutions described herein allow users to view the relevant information by using a synergistic operation of machine learning models as described herein to provide the information such as sentiment, topics, subtopics, resolution, etc. all in a single place or graphical user interface. The dashboard cannot be implemented as a mental process. Accurately reviewing significant electronic communications (e.g., 15,000 or more transcripts, hundreds to thousands of emails, thousands of chats) on a weekly basis and understanding flaws and possible solutions between a limited number of people is almost impossible to perform. Indeed, accuracy of some features, such as sentiment, also depends on an objective standard being applied to all transcripts, which is impossible for humans to implement since humans are naturally subjective when assessing emotions, topics and sentiments. Indeed, many humans determine sentiments and emotions based on their previous experiences which fluctuate wildly depending on the demographics, childhood and random events that occurred in the past of the humans. Further, doing so would be impossible in real time making the information inaccurate and aged. For example, it would take a user on average about an hour to read about 2-3 transcripts let alone the time to understand the topic and sentiment. Machine learning models described herein cut out the unreliable and flawed “middleman” to generate meaningful and important insights that allow users to make a meaningful impact in real time and/or automatically adjust processes.

For example, examples have been able to allow a pharmacy to generate a campaign to provoke physicians to sign up, using their devices, for an online portal (e.g., Accredo MAP, a medical provider portal on a server) that allows a physician to check a patient's prescription information. Doing so leads to a reduced contact volume which reduces resources (bandwidth, computing, human, etc.) since less contacts are received and initiated through electronic processes. Therefore, examples have had significant success with the campaign which can be seen on contact volumes and produce a tangible effect.

In one example, if the call volume for a particular topic is shown to increase at some points throughout the month, examples of the present system may pre-emptively and automatically generate an electronic communication informing parties of information related to the topic (e.g., a text stating that a next appointment is at TTT time on XX/YY/ZZ; an email stating that the information about the topic may be found at website ABC; an email and/or text invitation to invite customers to setup an online portal to monitor their health and schedule appointments, etc.). Doing so reduces computing resources and human resources since calls are reduced (e.g., many telephone calls are processed through an automated process to direct and potentially answer questions of the calls). The reduction in calls can be the number of calls or the duration of the calls.

Software can create specialized interactive characteristic display screens on the user's screen. The screen enables a user to enter and execute analysis to determine characteristics, obtain further data to analyze, and monitor characteristics. The range and quality of characteristics available to users on their screens varies according to the specific software application being run as well as user constraints. Such information can also be time sensitive in that situations can be quickly remediated in real time if certain characteristics are present. Furthermore, rapidly compiling and receiving a list of the characteristics can be a significant enhancement since previous implementations were unable to present useable and cognizant insights into the data, leading to sub-optimal actions and little understanding of the nature of the interactions. Indeed, examples herein can operate over massive quantities of data (e.g., 20,000+different communication sessions) in real time to provide valuable insights. Thus, examples add new functionality to computer processes to improve speed, accuracy and usability of characteristics of communication sessions. Indeed, examples herein can leverage the power and capabilities of several different models that are specifically designed and targeted to identify different characteristics.

In order to accomplish the above solutions, enhanced examples can classify an interaction from a communication session into a first category of a plurality of categories, identify a selected model from a plurality of models based on the communication being classified into the first category, and determine, with the selected model, a characteristic of the communication session.

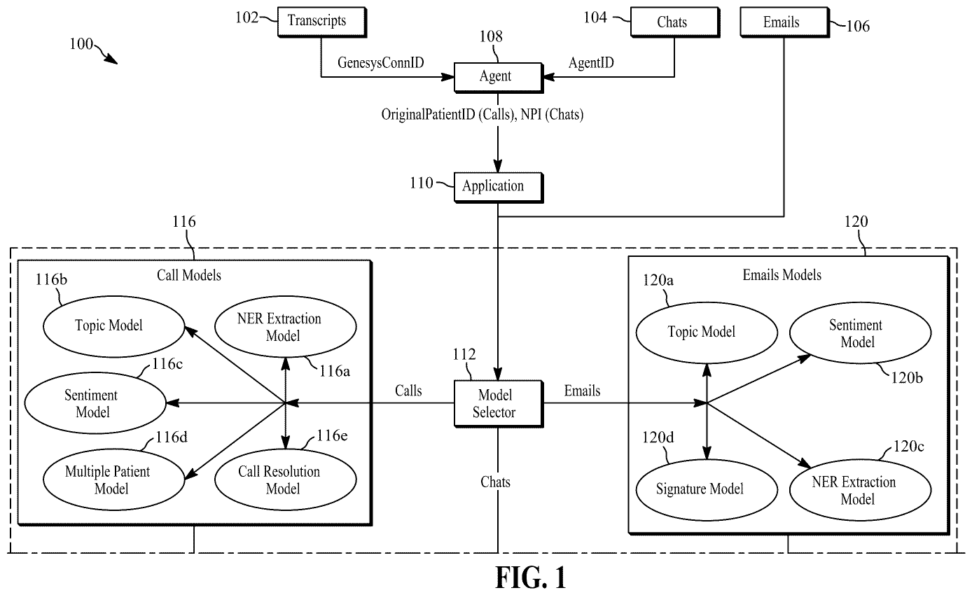

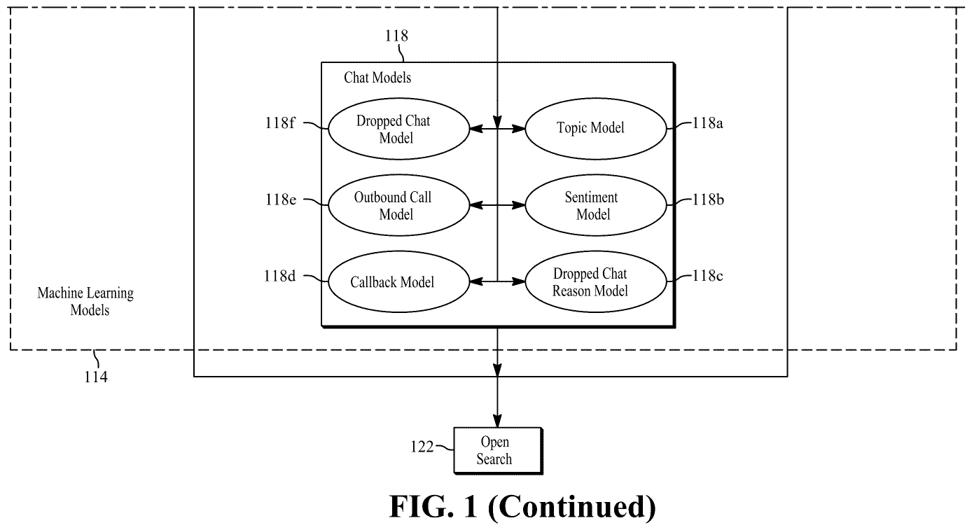

Turning now to FIG. 1, a communication session analysis architecture 100 is illustrated. The communication session analysis architecture 100 includes autonomously generated transcripts 102 (e.g., Databricks® generated and/or Verient® generated). Verint® records and transcribes communication sessions (e.g., calls and/or video conferencing), and the transcription is sent to Databricks® which holds all the values for the transcription (the database that holds the calls and/or video conferences). The autonomously generated transcripts 102 can be generated from conversations (e.g., phone calls) and/or video calls. Thus, the transcripts can be generated in an autonomous manner. In some examples, chats 104 (e.g., Genesys® live chat which can be an AI-powered live chat) can also be provided. Emails 106 are also available.

The autonomously generated transcripts 102 can be passed to an agent 108 (e.g., “Opsin sight” agent) along with corresponding connection identifications (IDs). The connection IDs can identify each specific telecommunication session (e.g., call session that includes telephony session and/or video session) by a unique identifier that is linked to the parties (e.g., customer, patient, doctor and/or employee) that participated in or is currently participating in the call session. The connection IDs can also link to and/or be associated with other features for the autonomously generated transcripts 102, such as when the call session occurred, a reason for the call session (e.g., if gathered through a user selection or statement during the phone/video call), length of the call session, etc. The connection IDs can be stored in a database with relational status to the data types associated with the connection.

The chats 104 can also be provided along with an agent ID. The agent IDs can identify each specific chat session by a unique identifier that is linked to the parties (e.g., customer, patient, doctor, employee and/or chatbot) that participated in or is currently participating in the chat session. A chat may be a real-time, text-based conversation between two or more participants using a digital platform. In some examples, one of the participants may be an autonomous agent programmed to respond to user inquiries. The agent IDs can also link to and/or be associated with other features for the chats 104, such as when the chat session occurred, a reason for the chat session (e.g., if gathered through a user selection or written during the chat), length of the chat session, etc. Thus, each specific chat session is associated with a unique identifier (agent ID) that is linked to customer and/or employee that participated in the chat session as well as other features relating to the chat session including the entire text of the chat session. The agent IDs can be stored in a database with relational status to the data types associated with the connection.

The agent 108 can retrieve and/or identify data such as patient ID, prescription number, agent location (that participated in a corresponding telephony session or chat session), etc. The agent 108 can provide original patient IDs (identifiers for patients to link the patients with unique records and contact information for the patients) for calls (video or telephone calls) of the autonomously generated transcripts 102 and a National Provider Identifier (e.g., 10-digit number that identifies health care providers) for the chats 104 to a cloud-based software application 110 (e.g., Rx: Home® software) that stores relevant details associated with patients and health providers (e.g., chart notes, physician details, etc.). The cloud-based software application 110 can provide similar such details for the emails 106. The cloud-based software application 110 can aggregate the autonomously generated transcripts 102, chats 104, and emails 106 that are originally in distinct and separate environments. That is, if two chats associated with the autonomously generated transcripts 102 are related (e.g., pertain to the same user and inquiry) the agent 108 may link the two chats together. Similarly, emails 106 and chats 104 may be grouped together.

The autonomously generated transcripts 102, chats 104 and emails 106 and any other relevant information that the agent 108 and cloud-based software application 110 have identified are provided to model selector 112. The model selector 112 can appropriately direct the autonomously generated transcripts 102, chats 104, and emails 106 to call models 116, chat models 118 and email models 120, respectively. In some examples, data related to a same user can be used across the call model 116, the chat model 118, and the email model 120

The model selector 112 can classify an interaction from a communication session from the autonomously generated transcripts 102, chats 104, and emails 106 into a first category of a plurality of categories (e.g., chat conversation category, call conversation category or email conversation category), identify a selected model from machine learning models 114 (e.g., machine learning models) based on the communication being classified into the first category, and determine, with the selected model, a characteristic of the communication session by processing communication data of the communication session (e.g., transcript, text, etc.) with neurons of the selected model.

For example, the model selector 112 can determine a medium of each distinct conversation (e.g., each chat conversation, each email conversation, each telephone and video conversation) from the data sent from the cloud-based software application 110. In detail, a first conversation can be classified as having occurred through email, which would then cause the first conversation to be classified into the email conversation category. A second conversation can be classified as having occurred through chat, which would then cause the second conversation to be classified into the chat conversation category. A third conversation can be classified as having occurred through a telephone (e.g., voice call) or video call, which would then cause the third conversation to be classified into the call category. The call category can include voice calls and/or video calls. As will be explained below, different models are applied to the first, second and third conversations to improve and enhance the efficiency and effectiveness of characteristic identification. That is, examples herein provide a unique mixture of models 114 that create a synergistic and innovative effect when operating together.

In this example, the model selector 112 provides the first conversation to email models 120 based on the first conversation being categorized into the email category. Thus, the data associated with the first conversation (e.g., text in the email of the first conversation, NPI number, chart information, identification information) can be provided to email models 120. The email models 120 include four distinct models (e.g., machine learning models that include one or more of naive bayes classifier, Linear Discriminant Analysis (LDA), an open-source Natural Language Processing (NLP) (e.g., Spark NLP pretrained models), k-means clustering, a pretrained Robustly Optimized Bidirectional Encoder Representations from Transformers Pretraining Approach (ROBERTa) model, etc.) that are each uniquely trained to identify a distinct characteristic. In some examples, each of the models of the email models 120 may be a uniquely trained LDA model which exhibits higher accuracy, precision and recall relative to other ML models. For example, a topic model 120a of the email models 120 determines a topic of the first conversation, a sentiment model 120b of the email models 120 determines a sentiment of the first conversation, a Named Entity Recognition (NER) model 120c of the email models 120 determines distinct entities mentioned or referenced in the conversation of the first conversation and a signature model of the email models 120 determines a signature (e.g., a user(s) who sent the emails) in the first conversation. A NER model 120c may be a natural language processing (NLP) technique used to extract structured data (like diagnoses, procedures, medications) from unstructured clinical text such as notes, conversations, discharge summaries, or claim narratives.

In some examples, the email models 120 can include a latent Dirichlet allocation (LDA) process which determines topics based on the data. For example, the LDA process can generate an N-dimensional space and maps conversations to the N-dimensional space (e.g., distance from various points in the space can indicate probabilities a word being associated with various topics of the various points). For example, each word of the first conversation can be mapped to the N-dimensional space and the overall probability of the first conversation belonging to a particular topic can be identified based on the individual probabilities of the words being associated with the various topics.

In some examples, the topic model 120a, sentiment model 120b, model 120c and signature models 120d of the email models 120 can be linked together to receive outputs from one another. For example, a sub-topic model (not illustrated) of the email models 120 can receive probabilities of the first conversation being associated with different topics from the topic model and can determine a sub-topic for the first conversation based on the probabilities. Similarly, a signature (e.g., doctor signature, patient signature, customer signature, customer representative signature) can also indicate a topic (e.g., prescription refill, status check of order, etc.) of the first conversation, and therefore an output (e.g., signature, type of person who signed the email, etc.) of the signature model 120d can be provided to the topic model 120a. The topic model 120a can therefore operate based on the signature provided by the signature model 120d. Accordingly, the email models 120 can be linked together to create a synergetic effect that increases accuracy and efficiency.

Similarly, the model selector 112 provides the second conversation to chat models 118 based on the second conversation being categorized into the chat category. Thus, the data associated with the second conversation (e.g., text in the chat, NPI number, chart information, identification information) can be provided to chat models 118. The chat models 118 include six distinct models (e.g., machine learning models such as Linear (Support Vector Classifier), Random Forest Classifier, Light Gradient Boosting Machine (LGBM), Extreme Gradient Boosting (XGboost), logistic ML model, Synthetic Minority Oversampling Technique (SMOTE), etc.) that are each trained to identify a distinct characteristic. In some examples, each of the ML models of the chat models 118 may be a unique SMOTE ML model which has enhanced accuracy, precision, and recall relative to other ML models. For example, a topic model 118a of the chat models 118 determines a topic of the second conversation, a sentiment model 118b of the chat models 118 determines a sentiment of the second conversation, a dropped chat reason model 118c of the chat models 118 determines a reason for the second conversation being dropped (e.g., frustrated user quit chat, solution was not identified, information unavailable, chat had difficulty handling a call, etc.). Furthermore, a callback model 118d of the chat models 118 determines whether a callback occurred after the second conversation to resolve or follow up on any outstanding issues from the chat, an outbound call model 118e of the chat models 118 determines whether an outbound call occurred based on the chat, and a dropped chat model 118f of the chat models 118 determines whether a chat was prematurely dropped (e.g., dropped without resolution being reached). The chat can include chatbots in some examples. Similar to above, the different models of the chat models 118 can be linked together to enhance accuracy. Furthermore, a sub-topic model can be part of the chat models 118.

Similarly, the model selector 112 provides the third conversation to call models 116 based on the third conversation being categorized into the telephony category. The call models 116 may be gradient boosting machines (GBMs). Each GBM is a machine-learning algorithm that combines multiple simple models (e.g., weak learners or shallow decision trees, into a single strong model). GBMs are trained by building models sequentially. Each simple model attempts to correct the errors made by the previous simple models through a process similar to gradient descent. Such an iterative approach allows the GBMS to achieve high accuracy but can also make the GBMS computationally expensive and prone to overfitting if not tuned properly.

Accordingly, examples herein improve the accuracy of the call models 116 through a multi-model approach where each model performs a different and specific function. For example, the data associated with the third conversation (e.g., transcript, NPI number, chart information, identification information) can be provided to call models 116. The call models 116 include five distinct models (e.g., each is a GBM) that are each trained to identify a distinct characteristic. For example, a topic model 116b of the call models 116 determines a topic of the third conversation, a sentiment model 116c of the call models 116 determines a sentiment of the third conversation, a name entity recognition (NER) extraction model 116a of the call models 116 determines an NER of the third conversation, a multiple patient model 116d of the call models 116 determines whether multiple patients participated in the third conversation, and a call resolution model 116e of the call models 116 determines whether the third conversation resulted in a resolution of an issue identified in the phone call of the third conversation (e.g., whether patient receive appropriate guidance based on an inquiry of the patient). The telephone conversation can be at least partly automated.

These models transform raw text (unstructured data) into structured data, enabling downstream tasks such as document indexing, semantic searching, compliance auditing, medical record parsing or the like. The NER can tokenize the unstructured data, tag the part of speech, detect the entity producing the tokenized data, classifies the tokenized data, and performing contextual disambiguation. The NER can use machine learning, e.g., transformers. Like BERT). An example use of a NER is described in provisional patent application No. 63/779,814, filed 28 Mar. 2025, titled ARTIFICIAL-INTELLIGENCE-BASED PRESCRIPTION PRIOR AUTHORIZATION VALIDATION, which is hereby incorporated by reference herein for any purpose.

Thus, the NER extraction model 116a, topic model 116b, sentiment model 116c, multiple patient model 116d, call resolution model 116e are each trained for a specific and different analysis. Furthermore, a sub-topic model can be part of the call models 116. Accordingly, the call models 116 operate with greater accuracy than if a single ML model attempted to identify a topic, NER, sentiment, patient, and call resolution. Therefore, the call models 116 is enhanced at least to the extent that the call models 116 is improved in accuracy.

For example, calls are often transcribed and then the call models 116 analyze the transcriptions to determine the characteristics. Such transcriptions are often inaccurate and present unique issues (e.g., homophones are misidentified, accents or unclear enunciation, technical jargon misunderstood, speaker identification errors such as misattribution of speaking, omissions, transcribing redundancy filler words, incorrect pronunciation, formatting issues, typographical errors, contextual misunderstandings such as failing to miss sarcasm, idioms, etc.). Therefore, the transcriptions present unique issues.

Accordingly, examples herein train NER extraction model 116a, topic model 116b, sentiment model 116c, multiple patient model 116d, call resolution model 116e for a different and specific characteristic identification. That is, each of the NER extraction model 116a, topic model 116b, sentiment model 116c, multiple patient model 116d, call resolution model 116e analyzes the transcriptions differently based on different terms present within the transcriptions. In some examples, each of the NER extraction model 116a, topic model 116b, sentiment model 116c, multiple patient model 116d and call resolution model 116e classify a call into a pre-defined bucket or class rather than making a unique and new classification. Doing so may facilitate data analysis while also increasing performance and efficiency. For example, the topic model 116b may classify a call into one of several categories (e.g., complaint, insurance inquiry, prescription refill, etc.).

Similar to above, the topic model 120a, sentiment model 120b, NER model 120c and signature model 120d can be linked together to enhance accuracy. Notably, the topic model 120a operates differently than the topic model 116b. The topic model 120a for example analyzes email which provides information in a different manner than a call with different contexts. For example, an email may not include transcription errors noted above, but may include typographical errors, human errors, pointed questions, etc. that are present in calls. Accordingly, the topic model 116b and the topic model 120a analyze data differently to determine a same characteristic (topic) from data. Therefore, the topic model 116b and the topic model 120a are trained differently from each other (e.g., a longer duration phone call indicates a problem occurred, while emails may not have a “duration,” rather a lengthy email thread with many emails may indicate a problem occurred). Similarly, the topic model 118a may be trained differently than the topic model 116b and topic model 120a since chats present a different context (hyper focused questions and answers, different flow to conversations, no filler words, etc.) than emails and calls.

Thus, each the call models 116, chat models 118 and email models 120 are trained specifically to identify various characteristics (e.g., topic, sentiment, NER, signatures, dropped chat reason, callback, outbound call, dropped chat, multiple patient, sub-topics, and call resolution) in different contexts. Doing so can provide significant enhancements relative to existing implementations. For example, employing a single machine learning model to identify the characteristics can result in significant inaccuracy and lowered efficiency. Examples herein adopt a granular approach of training different machine learning models 114 to identify different characteristics with a focus on the context of the conversation.

Moreover, a granular analysis of the characteristics of a conversation can facilitate real time enhancements in some cases. For example, suppose a chat is occurring and the chat models 118 analyze the chat. The sentiment model of the chat models 118 can determine that the sentiment indicates a patient participating in the chat is feeling upset or angry. Based on as much, a chatbot of the conversation can be replaced with a human operator, or the chatbot can be adjusted to rephrase answers and/or provide more detailed responses. In some examples, a phone call can be initiated to connect the patient with a human being and the chat can be closed. In some examples, if the sentiment of a conversation indicates that a user is becoming more frustrated, a company representative that is participating in the conversation can be immediately changed for a different company representative through an automated process that is implemented in a computer system. Thus, parameters of the computer system can be adjusted based on the identified characteristics. The characteristics can be referred to as “metrics” as well.

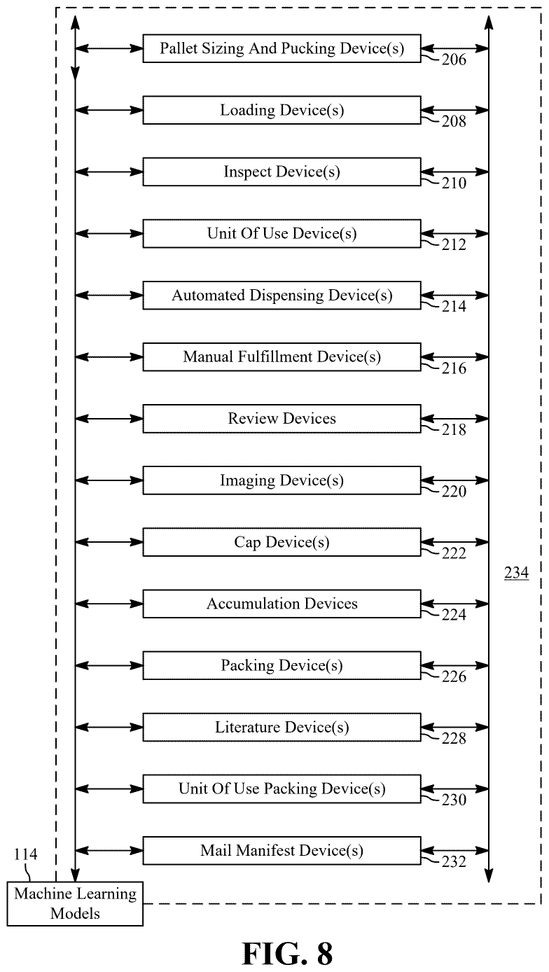

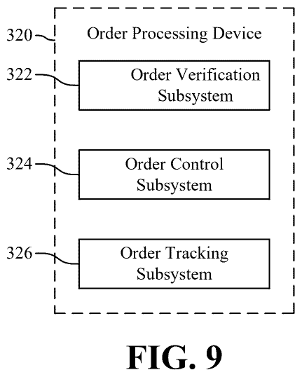

In some examples, if outputs of the call models 116, chat models 118 and email models 120 indicate that topics of conversations revolve around refilling a particular medication, an automated process may be executed. For example, an automated process to fulfill and process the medications may be performed (e.g., a robot fills the prescriptions) in anticipation of the medication being ordered. Such automated fulfillment is described in the pharmacy fulfillment device 234 of FIG. 8 and the order processing device 320 of FIG. 9. That is, in some examples the ML models 114 may operate directly with the pharmacy fulfillment device 234 of FIG. 8 and the order processing device 320 of FIG. 9 to directly fulfill anticipated prescriptions automatically, and in some cases prior to the anticipated prescriptions being formally ordered.

The characteristics output by the models 114 are stored into an open search 122 (e.g., Opensearch AWS®) as comma-separated values (CSV). Notably, the initial data from the cloud-based software application 110 is an unstructured data format that can be widely variable, making the unstructured data difficult to analyze and impossible to present in a meaningful way to illustrate insights. The output of the models 114 is stored into the open search 122 as structured format that is easily viewable and understandable by a human operator to make informed decisions. Therefore, the models 114 analyze, change and transform data from a first format (unstructured data format) into a second format (structured data format).

Thus, examples can provide an interactive dashboard to view and deep dive into analytical KPIs and meta data generated by the open search 122. The KPIs and supporting meta data are packaged into a large CSV file. Navigating the CSV file to find specific metrics is cumbersome and non-user friendly. Hence, examples bring the CSV data to a platform (graphical user interface) that can be concurrently accessed by multiple members at scale, and that has state of the art dashboarding capabilities allowing for quick changes without code changes or standard code deployments. Finally, a dashboarding platform that can be used as self-service to build new widgets and dashboards by non-technical teams with minimum to no learning curve can be a natural extension.

The open search 122 can present whether interactions (conversations) were positive or negative, as well as underlying reasons for the positivity or negativity (sentiment). Examples can also forecast and determine trends, for example whether people will call on a certain day to schedule shipments of products (e.g., drugs), whether doctors are seeing an increase in a particular virus, etc. In some examples, the trends can indicate that a remediation action can be scheduled. For example, if a particular doctor routinely calls for information that can be found online, the remediation action can include sending a push notification to the doctor to download and review details via an application.

Furthermore, in some examples the open search 122 can normalize the data. The outputs of the call models 116, chat models 118, email models 120 may have different nomenclatures, but may substantively be the same (e.g., patient John Doe, Customer 12345 and User 678 may all be identification for the same patient or customer). Normalization may include combining data that is substantively the same but has different labels and indexing the combined data with a same label (e.g., data is indexed as being associated with patient John Doe).

As noted, calls, chat and emails can use at least three different types of models to accomplish and identify particular characteristics or tasks (e.g., one for topic and/or subtopic, and one for sentiment). To train the models 114, thousands of manually annotated documents can be generated and then provided to the models 114 for training. Examples are able to achieve a high level of accuracy and precision in determining sentiment and topics among other characteristics. The data in Table I can be stored in data fields in a record stored in an electronic database for use by computer algorithms as described herein. Table 1 below shows various channels (e.g., communication mediums), models, uses, data used/available, whether data is ignored and if the output is weighted:

TABLE I

| | | | Data | Data | |
|---|---|---|---|---|---|
| Channel | Model | Use | Used/Available | Ignored | Weighted |
| Chat | Topic | Uses the chat | Chat Transcripts | Everything | No |
| | model | transcript and | from Genesys + | except | |
| | | identifies the | TRC + Chat | data used | |
| | | chat topic of | reason the | | |
| | | why a physician | customer | | |
| | | is contacting us. | chooses | | |
| Chat | Subtopic | Uses the chat | Chat Transcripts | Everything | No |
| | model | transcript and | from Genesys + | except | |
| | | identifies the | TRC + Chat | data used | |
| | | chat subtopic of | reason the | | |
| | | why a physician | customer | | |
| | | is contacting us. | chooses | | |
| Chat | Sentiment | Uses the chat | Chat Transcripts | Everything | No |
| | model | transcript and | from Genesys + | except | |
| | | identifies the | TRC + Chat | data used | |
| | | sentiment within | reason the | | |
| | | the chat of the | customer | | |
| | | physician. | chooses | | |
| Chat | Dropped | Uses the chat | Chat Transcripts | Everything | No |
| | Chat | transcript and | from Genesys + | except | |
| | model | identifies if the | TRC + Chat | data used | |
| | | chat was | reason the | | |
| | | dropped or not. | customer | | |
| | | | chooses | | |
| Chat | Outbound | Uses the chat | Chat Transcripts | Everything | No |
| | Call | transcript and | from Genesys + | except | |
| | model | identifies if the | TRC + Chat | data used | |
| | | chat agent | reason the | | |
| | | contacted the | customer | | |
| | | physician/patient | chooses | | |
| | | during the chat. | | | |
| Chat | Callback | Uses the chat | Chat Transcripts | Everything | No |
| | model | transcript and | from Genesys + | except | |
| | | identifies if the | TRC + Chat | data used | |
| | | physician | reason the | | |
| | | provides a | customer | | |
| | | callback number | chooses | | |
| | | during the chat. | | | |
| Chat | Multiple | Uses the Chat | Chat Transcripts | Everything | No |
| | Patient | transcript and | from Genesys | except | |
| | model | identifies if the | | data used | |
| | (NER | call handled | | | |
| | Extraction | more than one | | | |
| | model) | patient by | | | |
| | | identifying | | | |
| | | patient name, | | | |
| | | patient date of | | | |
| | | birth and patient | | | |
| | | id | | | |
| Chat | Dropped | Uses the chat | Chat Transcripts | Everything | No |
| | Chat | transcript and | from Genesys | except | |
| | Reason | identifies why | | data used | |
| | model | the chat was | | | |
| | | dropped, if | | | |
| | | dropped. | | | |
| Call | Topic | Uses the call | Call Transcripts | Everything | No |
| | model | transcript and | from Verint, | except | |
| | | identifies the | Chartnotes from | data used | |
| | | call topic of why | RXhome | | |
| | | a physician is | | | |
| | | contacting us. | | | |
| Call | Subtopic | Uses the call | Call Transcripts | Everything | No |
| | model | transcript and | from Verint, | except | |
| | | identifies the | Chartnotes from | data used | |
| | | call subtopic of | RXhome | | |
| | | why a physician | | | |
| | | is contacting us. | | | |
| Call | Sentiment | Uses the call | Call Transcripts | Everything | No |
| | model | transcript and | from Verint | except | |
| | | identifies the | | data used | |
| | | sentiment within | | | |
| | | the chat of the | | | |
| | | physician. | | | |
| Call | Multiple | Uses the call | Call Transcripts | Everything | No |
| | Patient | transcript and | from Verint | except | |
| | model | identifies if the | | data used | |
| | | call handled | | | |
| | | more than one | | | |
| | | patient. | | | |
| Call | Call | Uses the call | Call Transcripts | Everything | No |
| | Resolution | transcript and | from Verint, | except | |
| | model | identifies if the | Rxhome | data used | |
| | | call was | prescription | | |
| | | resolved or not. | status | | |
| Call | NER | Uses the call | Call Transcripts | Everything | No |
| | Extraction | transcript and | from Verint, | except | |
| | model | identifies the | Chartnotes from | data used | |
| | | pertinent | RXhome, | | |
| | | information in | Opsinsight | | |
| | | the call. (Names, | patient/physician | | |
| | | NPI, Drug | data | | |
| | | names, etc.) | | | |
| Call | Call | Uses the call | Call Transcripts | Everything | No |
| | Transfer | transcript along | from Verint, | except | |
| | model | with chartnotes | Chartnotes from | data used | |
| | | and identifies if | RXhome, | | |
| | | the call was | | | |
| | | transferred or | | | |
| | | not. (Names, | | | |
| | | NPI, Drug | | | |
| | | names, etc.) | | | |
| Email | Topic | Uses the email | Email | Everything | No |
| | model | transcript and | Transcripts from | except | |
| | | identifies the | Outlook | data used | |
| | | email topic of | | | |
| | | why a physician | | | |
| | | is contacting us. | | | |
| Email | Sentiment | Uses the email | Email | Everything | No |
| | model | transcript and | Transcripts from | except | |
| | | identifies the | Outlook | data used | |
| | | sentiment within | | | |
| | | the email with | | | |
| | | the physician. | | | |
| Email | NER | Uses the email | Email | Everything | No |
| | Extraction | transcript and | Transcripts from | except | |
| | model | identifies the | Outlook | data used | |
| | | pertinent | | | |
| | | information in | | | |
| | | the email. | | | |
| | | (Names, NPI, | | | |
| | | Drug names, | | | |
| | | etc.) | | | |
| Email | Signature | Uses the email | Email | Everything | No |
| | model | transcript and | Transcripts from | except | |
| | | identifies the | Outlook | data used | |
| | | signature line. | | | |

Thus, examples can be built through mainly manual annotation (supervised training methods). Examples can use thousands of call, chat, and email records to manually annotate features such as names, dates, medication information, etc. to then use as a training point for the models 114 (counts are below in Table II). Doing so enables a high efficiency in terms of gathering pertinent information within the transcripts itself such as sentiments and topics. The data in Table II can be stored in data fields in a record stored in an electronic database for use by computer algorithms as described herein. Examples currently pull data weekly which is then run through the models 114 which then allows permits data gathering. Table II is provided below:

TABLE II

| Type | Physician Annotation Count |
|---|---|
| Calls | >20,000 Physician; >2,400 Patient |
| Chats | >4,500 |
| Emails | >11,000 |
| Chart Notes | >15,000 |
| Call Transfer Reasons | >1,100 |
| Subtopic | >3,000 |
| Total | >58,000 |

Table II shows the annotated data broken down by category and communication medium.

The network(s) connecting the various components of communication session analysis architecture 100 can include, or operate in conjunction with, an ad hoc network, an intranet, an extranet, a virtual private network (VPN), a local area network (LAN), a wireless network, a low energy Bluetooth (BLE) connection, a WiFi direct connection, a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network can include a wireless or cellular network and the coupling can be a Code Division Multiple Access (CDMA) connection, a Global System for Mobile communications (GSM) connection, or other type of cellular or wireless coupling. In this example, the coupling can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, fifth generation wireless (5G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

Aspects of the communication session analysis architecture 100 can be implemented be implemented in logic instructions (e.g., software), configurable logic, fixed-functionality hardware logic, computer readable instructions stored on at least one non-transitory computer readable storage medium that are executable to implement aspects of the communication session analysis architecture 100, circuitry, etc., or any combination thereof. The communication session analysis architecture 100 can be a computing architecture, in which any of the components are executed in logic instructions (e.g., software), configurable logic, fixed-functionality hardware logic, computer readable instructions stored on at least one non-transitory computer readable storage medium that are executable to implement on the communication session analysis architecture 100, circuitry, etc., or any combination thereof.

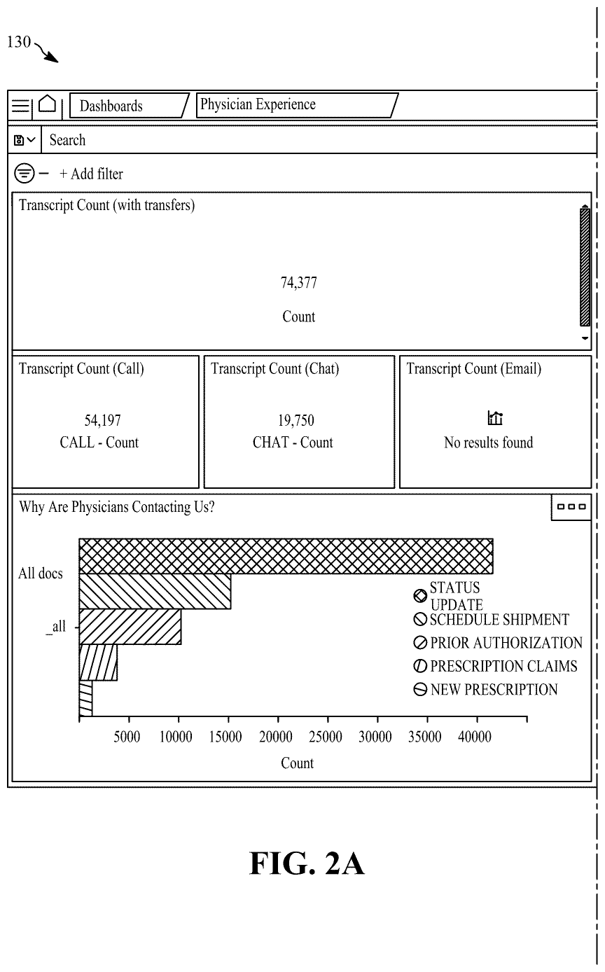

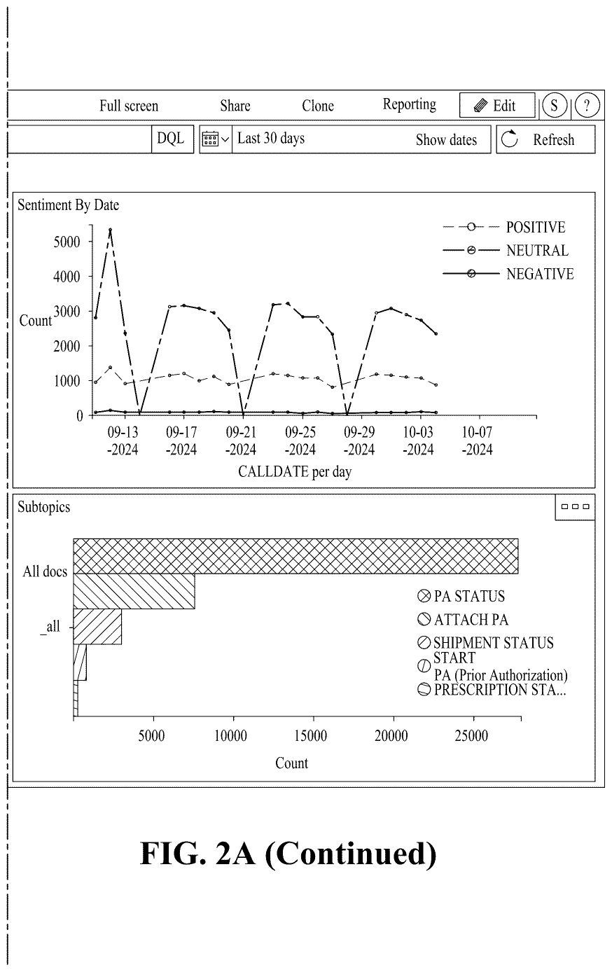

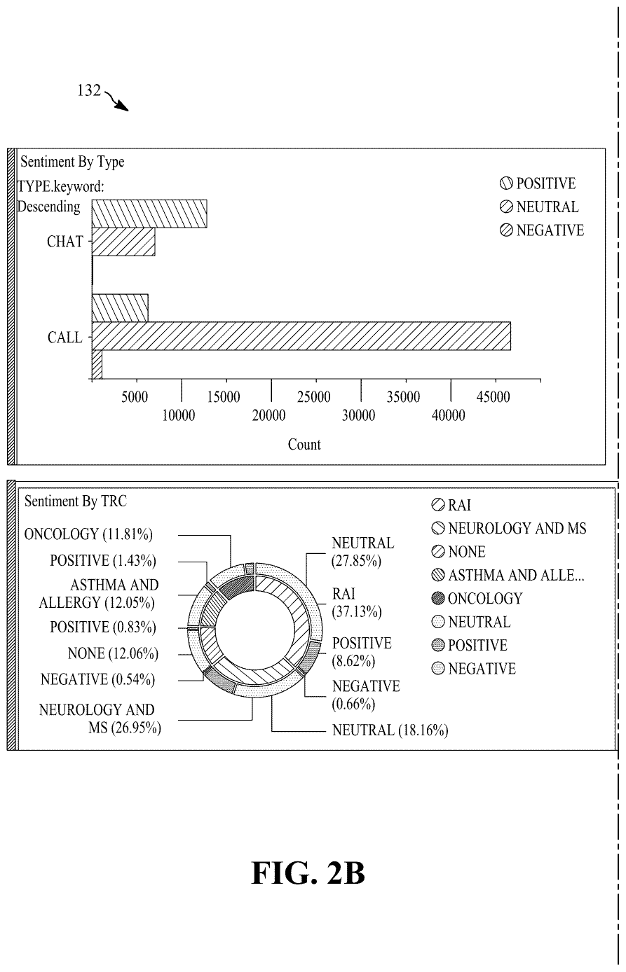

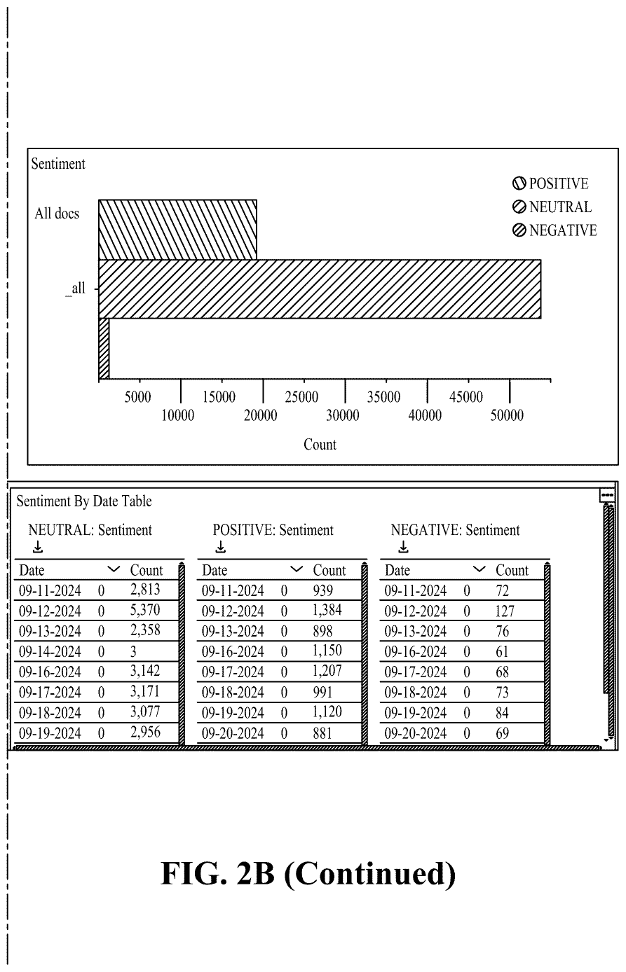

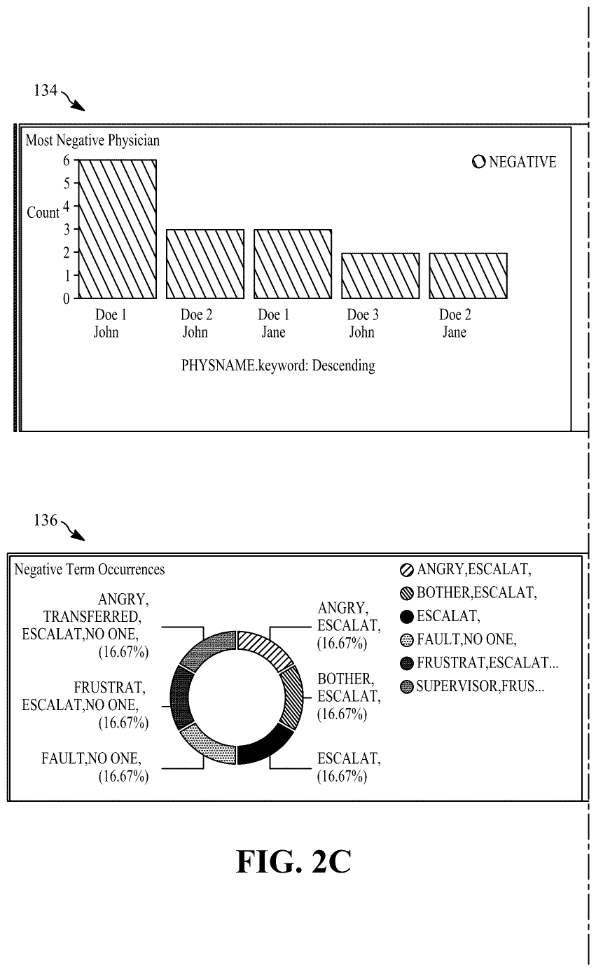

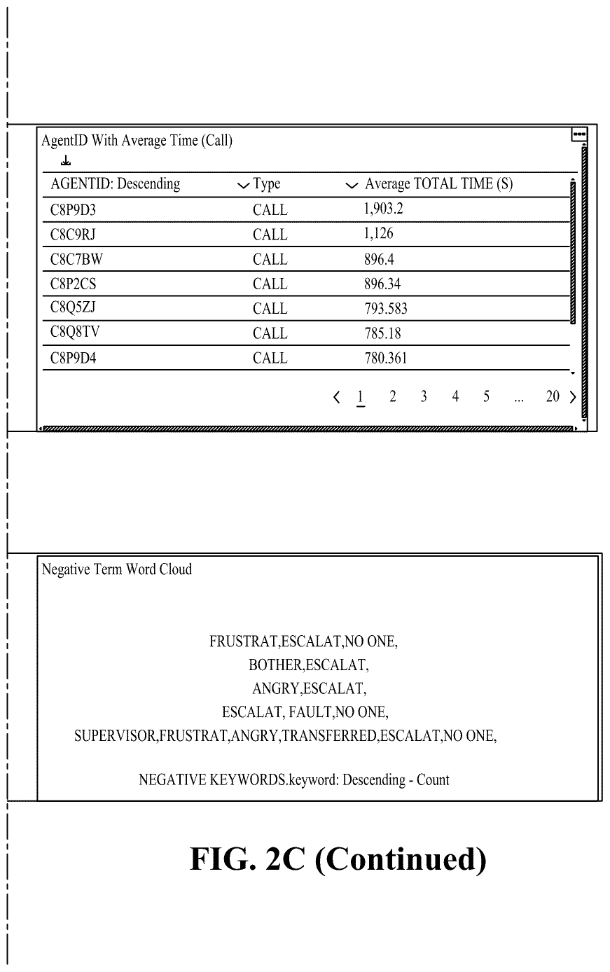

Turning now to FIG. 2A, a first GUI 130 illustrating the outputs of the open search 122 (FIG. 1) is illustrated. The first GUI 130 can be presented on a display of a computing device or other electronic display screen. In this example, the first GUI 130 includes a call count for “why are physicians contacting us” as well as “subtopics.” FIG. 2B illustrates a second GUI 132 that illustrates the outputs of the open search 122 (FIG. 1). The second GUI 132 illustrates sentiments by type and associated counts. A circular sentiment graph is also provided in the lower portion of the second GUI 132. FIG. 2C illustrates a third GUI 134 that illustrates outputs of the open search 122 (FIG. 1). The third GUI 134 illustrates the most negative physicians and associated calls. A fourth GUI 136 illustrates outputs of the open search 122 (FIG. 1). The fourth GUI 136 shows the negative terminologies that are most frequently used.

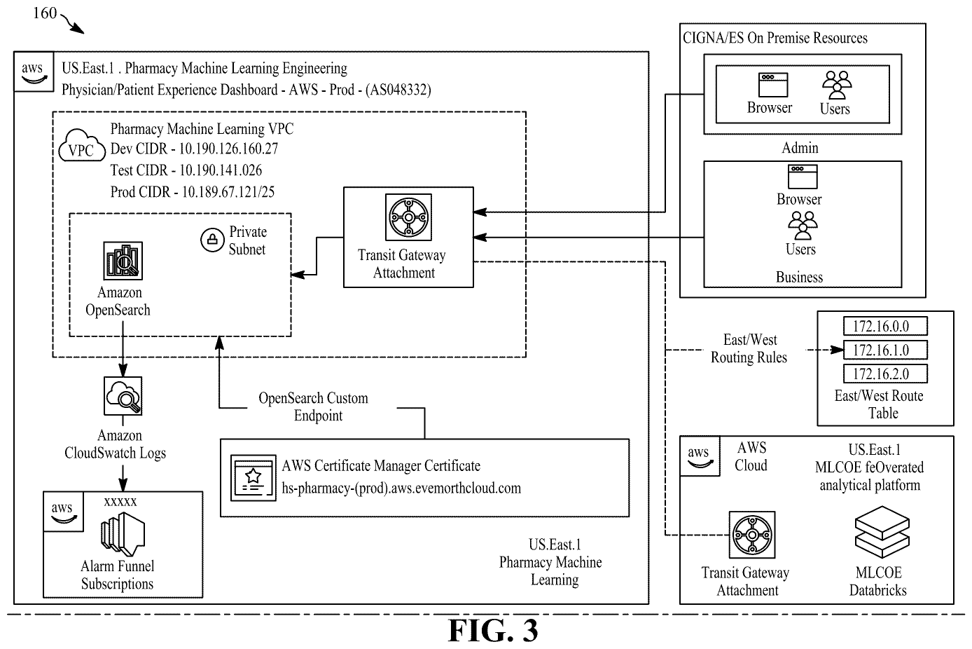

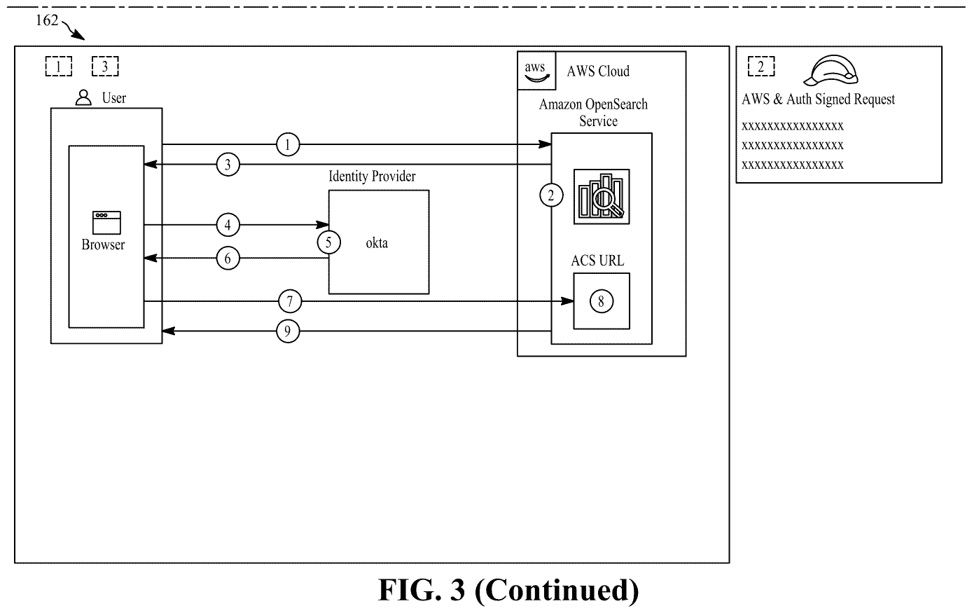

FIG. 3 illustrates an open search architecture diagram 160 that can operate in conjunction with any of the examples herein, including the communication session analysis architecture 100 (FIG. 1), first GUI 130 (FIG. 2A), second GUI 132 (FIG. 2B), third GUI 134 (FIG. 2C) and fourth GUI 136 (FIG. 2C). Process 162 illustrates an open search implementation of the open search architecture diagram 160 and can be incorporated as part of open search 122 (FIG. 1). At action 1, a user opens a browser window and navigates to an “OpenSearch Dashboard” through a Uniform Resource Locator (URL). At action 2, an OpenSearch services generates a Security Assertion Markup Language (SAML) authentication request. At action 3, the OpenSearch service redirects requests back to the browser. At action 4, the browser redirects to an internal Okta® URL. At action 5, the Okta® parses the SAML request, authenticates the user and generates an SAML response. At action 6, the Okta® returns the encoded SAML response to the browser. At action 7, the browser sends the SAML response back to the OpenSearch Service Assertion Consumer Services (ACS) URL. At action 8, the ACS verifies the SAML response. At action 9, the user logs into the OpenSearch service domain.

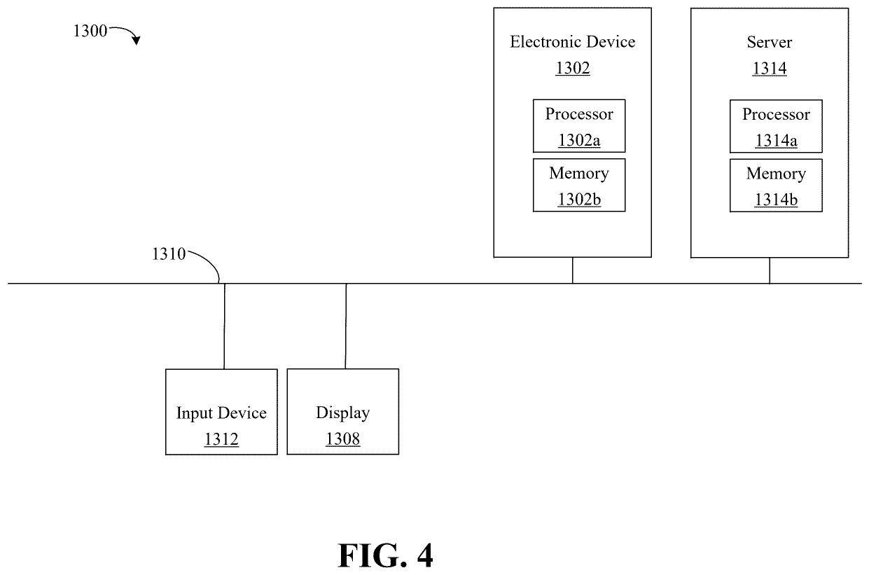

FIG. 4 shows a more detailed example of a computing architecture 1300 to execute a characteristic identification process. The computing architecture 1300 can generally be implemented in conjunction with any of the examples described herein, for example communication session analysis architecture 100 (FIG. 1), first GUI 130 FIG. 2A), second GUI 132 (FIG. 2B), third GUI 134 (FIG. 2C), fourth GUI 136 (FIG. 2C), open search architecture diagram 160 (FIG. 3) and/or process 162 (FIG. 3).

In the illustrated example, the computing architecture 1300 can include a network 1310 that can facilitate communication between server 1314, electronic device 1302 (e.g., part of a network), input device 1312, and display 1308. The display 1308 (e.g., audio and/or visual interface) can present characteristic notifications to a user, and the input device 1312 can receive user inputs (e.g., characteristic test initiation, compliance testing, etc.).

The server 1314 includes a processor 1314a (e.g., embedded controller, central processing unit/CPU) and a memory 1314b (e.g., non-volatile memory/NVM and/or volatile memory) containing a set of instructions, which when executed by the processor 1314a, cause the server 1314 to implement aspects described herein to determine characteristics.

The electronic device 1302 includes a processor 1302a (e.g., embedded controller, central processing unit/CPU) and a memory 1302b (e.g., non-volatile memory/NVM and/or volatile memory) containing a set of instructions, which when executed by the processor 1302a, cause the electronic device 1302 to implement aspects described herein. The processor 1302a, when loaded with instructions of the algorithmic tasks described herein, is a dedicated machine to performing the methodology described herein.

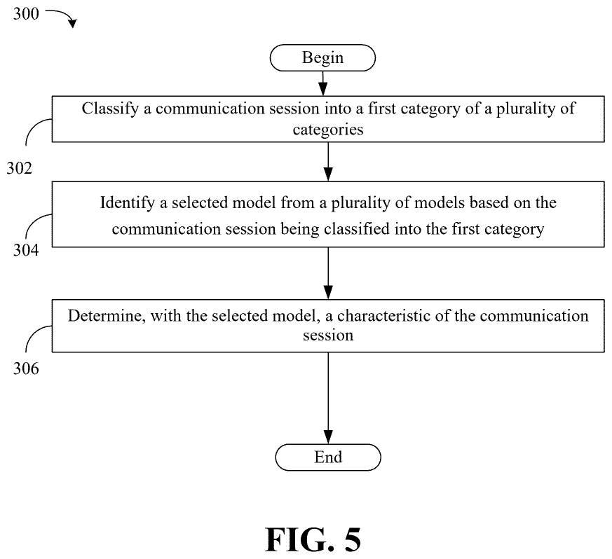

FIG. 5 illustrates a method 300 that determines characteristics of conversations. The method 300 can generally be implemented in conjunction with any of the embodiments described herein, for example the communication session analysis architecture 100 (FIG. 1), first GUI 130 FIG. 2A), second GUI 132 (FIG. 2B), third GUI 134 (FIG. 2C), fourth GUI 136 (FIG. 2C), open search architecture diagram 160 (FIG. 3) and/or process 162 (FIG. 3). In an embodiment, the method 300 is implemented in logic instructions (e.g., software), configurable logic, fixed-functionality hardware logic, computer readable instructions stored on at least one non-transitory computer readable storage medium that are executable to implement method 300, circuitry, etc., or any combination thereof.

Illustrated processing block 302 classifies a communication session into a first category of a plurality of categories. Illustrated processing block 304 identifies a selected model from a plurality of models based on the communication session being classified into the first category. Illustrated processing block 306 determines, with the selected model, a characteristic of the communication session. Examples can further adjust a parameter of the communication session based on the characteristic, and present the characteristic on a graphical user interface. Examples can further schedule a remediation action based on the characteristic. In some examples, a first plurality of machine learning models that are dedicated to determining chat characteristics of chat conversations, a second plurality of machine learning models that are dedicated to determining call characteristics of telephony conversations, and a third plurality of machine learning models that are dedicated to determining email characteristics of emails, where the selected model includes the first plurality of machine learning models, the second plurality of machine learning models or the third plurality of machine learning models.

In some examples, the first category is a chat category, and the characteristic include one or more of a topic, a sub-topic, a sentiment, whether a chat of the communication session is dropped, a reason for the chat being dropped if the chat is dropped, whether a chat agent contacted a third-party, whether a callback number was provided, or a name. In some examples, the first category is a call category, and the characteristic include one or more of a topic, a sentiment, a sub-topic, a name, whether a call of the of the communication session was transferred, whether the call was resolved, whether the call is associated with multiple users, or a name. In some examples, the first category is an email category, and the characteristic includes one or more of a topic, a sentiment, a sub-topic, a name, or a signature.

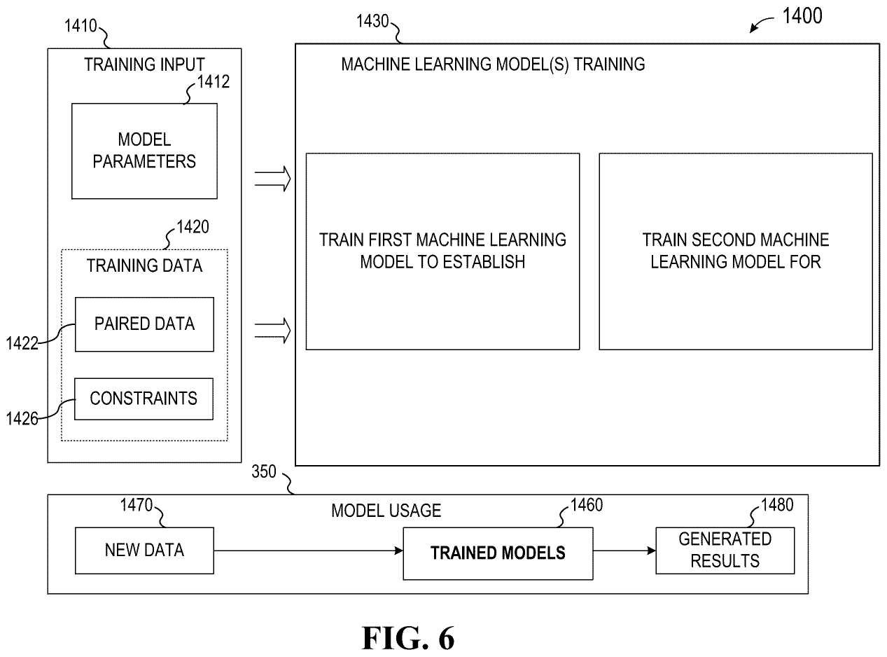

FIG. 6 is a block diagram of an example service of enhanced teleservice process/system 1400 that may be deployed within and/or in conjunction with the examples herein, including communication session analysis architecture 100 (FIG. 1) and in particular each of the call models 116, chat models 118 and email models 120, first GUI 130 FIG. 2A), second GUI 132 (FIG. 2B), third GUI 134 (FIG. 2C), fourth GUI 136 (FIG. 2C), open search architecture diagram 160 (FIG. 3), process 162 (FIG. 3), computing architecture 1300 (FIG. 4) and/or method 300 (FIG. 5) according to some examples. Training input 1410 includes model parameters 1412 and training data 1420, which may include paired training data sets 1422 (e.g., input-output training pairs) and constraints 1426. Model parameters 1412 store or provide the parameters or coefficients of corresponding ones of machine learning models. During training, these parameters 1412 are adapted based on the input-output training pairs of the training data sets 1422. After the parameters 1412 are adapted (after training), the parameters are used by trained models 1460 to implement the trained machine learning models on a new set of data 1470 from model usage 350.

Training data 1420 includes constraints 1426 which may define the constraints of a given patient information features. The paired training data sets 1422 may include sets of input-output pairs, such as pairs of a plurality of training virtual telehealth encounter transcription features and features of post patient encounter documents that are created in association with one or more of the training transcriptions (e.g., ground-truth patient encounter documents of conversations which are labelled). Some components of training input 1410 may be stored separately at a different off-site facility or facilities than other components.

Machine learning model(s) training 1430 trains one or more machine learning techniques based on the sets of input-output pairs of paired training data sets 1422. For example, the model training 1430 may train the machine learning (ML) model parameters 1412 by minimizing a loss function based on one or more ground-truth patient encounter documents generated in association with a training transcription. The ML model can include any one or combination of classifiers or neural networks, such as an artificial neural network, a convolutional neural network, an adversarial network, a generative adversarial network, a deep feed forward network, a radial basis network, a recurrent neural network, a long/short term memory network, a gated recurrent unit, an auto encoder, a variational autoencoder, a denoising autoencoder, a sparse autoencoder, a Markov chain, a Hopfield network, a Boltzmann machine, a restricted Boltzmann machine, a deep belief network, a deep convolutional network, a deconvolutional network, a deep convolutional inverse graphics network, a liquid state machine, an extreme learning machine, an echo state network, a deep residual network, a Kohonen network, a support vector machine, a neural Turing machine, an LLM, a generative network, a diffusion model, and the like.

Particularly, the ML model can be applied to a training batch of transcription features to estimate or generate one or more preliminary patient encounter documents. In some implementations, a derivative of a loss function is computed based on a comparison of the preliminary patient encounter documents and the ground truth patient encounter documents associated with the training transcription features and parameters of the ML model are updated based on the computed derivative of the loss function.

The result of minimizing the loss function for multiple sets of training data trains, adapts, or optimizes the model parameters 1412 of the corresponding ML models. In this way, the ML model is trained to establish a relationship between a plurality of training transcriptions and ground-truth patient encounter documents associated with the training transcriptions.

After the machine learning model is trained, new data 1470, including one or more transcriptions of a virtual clinical encounter features are received and/or derived by the communication session analysis architecture 100. The trained machine learning model may be applied to the new data 1470 to generate results 1480 including characteristics of conversations. The characteristics can be represented in a GUI, such as in a prompt overlaid on the GUI allowing a user to selectively include or exclude portions of the characteristics in different formats.

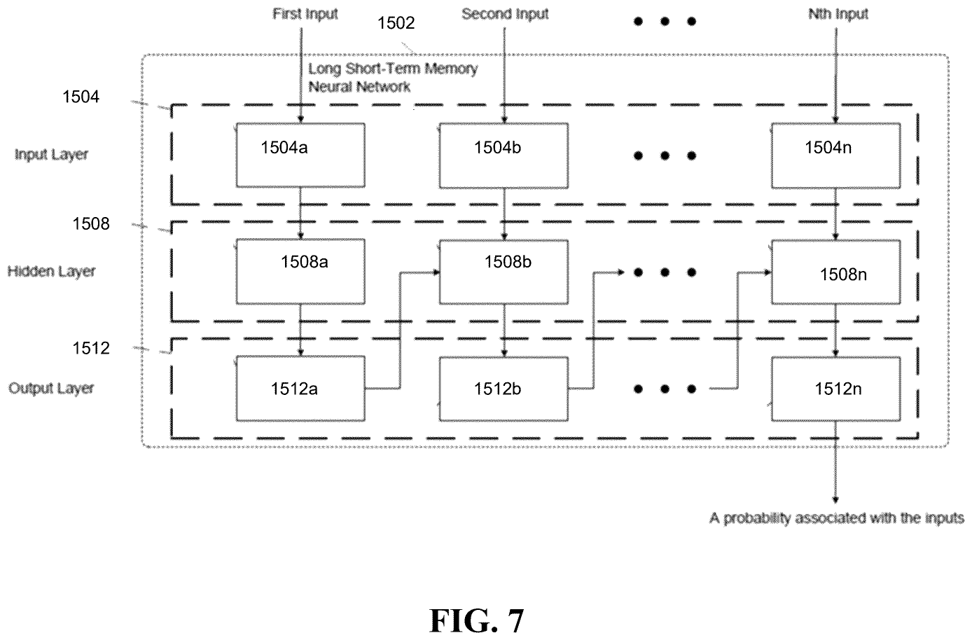

FIG. 7 is a functional block diagram of an example neural network 1502 that can be used for the inference engine or other functions (e.g., engines) as described herein to produce a predictive model. Neural network 1502 may be deployed within and/or in conjunction with the examples herein, including communication session analysis architecture 100 (FIG. 1) and for each of the call models 116, chat models 118, and email models 120, first GUI 130 (FIG. 2A), second GUI 132 (FIG. 2B), third GUI 134 (FIG. 2C), fourth GUI 136 (FIG. 2C), open search architecture diagram 160 (FIG. 3), process 162 (FIG. 3), computing architecture 1300 (FIG. 4) and/or method 300 (FIG. 5) according to some examples. The predictive model can identify or generate characteristics of a conversation. In an example, the neural network 1502 can be a LSTM neural network. In an example, the neural network 1502 can be a recurrent neural network (RNN). The example neural network 1502 may be used to implement the machine learning as described herein, and various implementations may use other types of machine learning networks. The neural network 1502 includes an input layer 1504, a hidden layer 1508, and an output layer 1512. The input layer 1504 includes inputs 1504a, 1504b . . . 1504n. The hidden layer 1508 includes neurons 1508a, 1508b . . . 1508n. The output layer 1512 includes outputs 1512a, 1512b . . . 1512n.

Each neuron of the hidden layer 1508 receives an input from the input layer 1504 and outputs a value to the corresponding output in the output layer 1512. For example, the neuron 1508a receives an input from the input 1504a and outputs a value to the output 1512a. Each neuron, other than the neuron 1508a, also receives an output of a previous neuron as an input. For example, the neuron 1508b receives inputs from the input 1504b and the output 1512a. In this way the output of each neuron is fed forward to the next neuron in the hidden layer 1508. The last output 1512n in the output layer 1512 outputs a probability associated with the inputs 1504a-1504n. Although the input layer 1504, the hidden layer 1508, and the output layer 1512 are depicted as each including three elements, each layer may contain any number of elements. Neurons can include one or more adjustable parameters, weights, rules, criteria, or the like.

In various implementations, each layer of the neural network 1502 must include the same number of elements as each of the other layers of the neural network 1502. For example, training GUI features (e.g., fields of a GUI presented to an operator) may be processed to create the inputs 1504a-1504n. The neural network 1502 may implement a model to produce one or more preliminary post patient encounter document in association with the transcript features. More specifically, the inputs 1504a-1504n can include fields of the transcript as data features (binary, vectors, factors or the like) stored in the storage device. The fields of the transcript as data features can be provided to neurons 1508a-1508n for analysis and connections between the known facts. The neurons 1508a-1508n, upon finding connections, provides the potential connections as outputs to the output layer 1512, which determines a preliminary post patient encounter document.

The neural network 1502 can perform any of the above calculations. The output of the neural network 1502 can be used to trigger display of a prompt that includes the preliminary post patient encounter document in a GUI. For example, the prompt (e.g., notification) can be provided to a PBM, health plan manager, pharmacy, physician, clinician, caregiver, and/or a patient.

In some examples, a convolutional neural network may be implemented. Similar to neural networks, convolutional neural networks include an input layer, a hidden layer, and an output layer. However, in a convolutional neural network, the output layer includes one fewer output than the number of neurons in the hidden layer and each neuron is connected to each output. Additionally, each input in the input layer is connected to each neuron in the hidden layer. In other words, input 1504a is connected to each of neurons 1508a, 1508b . . . 1508n.

The models described herein can be parametric machine learning models that generate the output based on the received input and on values of the parameters (e.g., weighting) at the neurons of the model. Some machine learning models are deep models that employ multiple layers of models to generate an output for a received input. For example, a deep neural network is a deep machine learning model that includes an output layer and one or more hidden layers that each apply a non-linear transformation to a received input to generate an output. However, machine learning models may be subject to “catastrophic forgetting” when trained on multiple tasks, losing knowledge of a previous task when a new task is learned. Some neural networks are recurrent neural networks. A recurrent neural network can be a neural network that receives an input sequence and generates an output sequence from the input sequence. In particular, a recurrent neural network uses some or all of the internal state of the network after processing a previous input in the input sequence in generating an output from the current input in the input sequence. The models can be executed on application specific circuits that are dedicated to the neural network structure and the function of the model. In an example, the application specific circuit defines the neurons and store the parameters. The parameters can be adjusted to optimize the performance of the model as a whole. Through use of the models described herein the parameters can be fine-tuned and grounded. In an example, the fine-tuning can be supervised for specific tasks associated with one of the text messages, call transcripts, call recordings (audio files), email, or scanned communications from a member. Fine-tuning can include adjusting a model using the entity's data to make subtle adjustments to the parameters based on the data sets known to the entity. Grounding can tie answers from the model to specific data.

The model can be trained or updated in a computer-implemented environment as described herein by setting or adjusting at least a plurality of parameters with the circuitry. Certain tasks are trained on a first machine learning task using first training data to determine first values of the plurality of parameters of the machine learning model. For each of the plurality of parameters, a respective measure of an importance of the parameter to the first machine learning task are determined. Based on the first values of the plurality of parameters determined by training the machine learning model on the first machine learning task, an approximation of a posterior distribution over possible values of the plurality of parameters can be calculated. Using the approximation, a value to each of the plurality of parameters is assigned. In an example, the value is the respective measure of the importance of the parameter to the first machine learning task and approximating a probability that the first value of the parameter after the training on the first machine learning task is a correct value of the parameter given the first training data used to train the machine learning model on the first machine learning task. The training obtains second training data for training the machine learning model on a second, different machine learning task. The training continues by training the machine learning model on the second machine learning task by training the machine learning model on the second training data to adjust the first values of the plurality of parameters to optimize performance of the machine learning model on the second machine learning task while protecting performance of the machine learning model on the first machine learning task. The training can adjust the first values of the plurality of parameters to optimize an objective function that depends in part on a penalty term that is based on the determined measures of importance of the plurality of parameters to the first machine learning task. The first machine learning task and the second machine learning task can be different tasks.

The neural network for the models described herein can include an input layer including n neurons (e.g., nodes), x₁, x₂, x₃, and xₙ. The input layer may have any number of nodes. In various implementations, each node may represent any numerical value. For example, each node may represent a numerical value in a range of between 0 and 1. So, for example, the nodes of the input layer could be expressed in interval notation as: x₁∈[0,1], x₂∈[0,1], x₃∈[0,1], and xₙ∈[0,1]. In various implementations, the input variables to a neural network may be expressed as a vector i having n dimensions. In an example, input vector i may be represented by equation (1) below:

$$i = 〈 {x}_{1} , {x}_{2} , {x}_{3} , {x}_{n} 〉 . \qquad ( 1 )$$

Each of the nodes may be multiplied by a weight-represented by w₁, w₂, w₃, and wₙ—before being fed into a node in the next layer. In an example, there are no hidden layers, the next layer is the output layer. The output layer may include any number of nodes. There can be multiple intermediate layers.

At the node in the next layer, the inputs of the node can be summed. Thus, because the inputs of the node in the output layer are the numerical value of each of the nodes of the previous layer multiplied by a weighting, the summation Σ may be represented by equation (2) below:

$$\sum = {x}_{1} {w}_{1} + {x}_{2} {w}_{2} + {x}_{3} {w}_{3} + {x}_{n} {w}_{n} . \qquad ( 2 )$$

In various implementations, a bias b may be added to the nodes x of the previous layer after they have been multiplied by a weight w. For example, if biases b are added, then summation 2 may be represented by equation (3) below:

$$\sum = ( {x}_{1} {w}_{1} + {b}_{1} ) + ( {x}_{2} {w}_{2} + {b}_{2} ) + ( {x}_{3} {w}_{3} + {b}_{3} ) + ( {x}_{n} {w}_{n} + {b}_{n} ) \qquad ( 3 )$$

The summation Σ may then be fed into an activation function ƒ. The activation function ƒ may be any mathematical function suitable for calculating an output for the node. Example activation functions ƒ may include linear or non-linear functions, step functions such as the Heaviside step function, derivative or differential functions, monotonic functions, sigmoid or logistic activation functions, rectified linear unit (ReLU) functions, and/or leaky ReLU functions. The output of the function ƒ is then the output of the node. In a neural network with no hidden layers, the output of the nodes in the output layer are the output variables or output vector of the neural network.

The neural network may one or more intermediate layers, e.g., hidden layers, between the input layer and the output layer. The neural network with hidden layers may be referred to as a multilayer perceptron. Each node of a hidden layer may be connected to one or more nodes of the previous layer and receive inputs from the connected nodes of the previous layer—such as the value of the node of the previous layer multiplied by a weight (xₙwₙ) or the value of the node of the previous layer multiplied by a weight with a bias added (xₙwₙ+bₙ). Each node of the hidden layer may then function in a manner analogous to the node of the output layer described above by summing the inputs, feeding the summed inputs into an activation function, and feeding the output of the activation function into one or more nodes of the next layer. Similarly, the nodes of the output layer function in a manner analogous to the node of the output layer described above. For example, the nodes of the output layer may receive the outputs of the nodes of the previous layer (multiplied by a weight and/or with a bias added as desired) as inputs, sum the received inputs, feed the summed inputs to an activation function, and output the result of the activation function as an output of the neural network.

The present systems and methods can process the audio and/or textual component of a conversation to assist in determining various characteristics of the patient, customer representative, doctor, or the user. The audio signal of a communication session between a patient-related client device and a provider client device can be processed in essentially real time. The audio signal is processed to separate the audio caller (patient) utterance to generate an identified task based on the transcribed caller utterance. The audio caller utterance is parsed into a plurality of samples of the audio caller utterance(s). The samples can be processed to generate a loudness result based on loudness values of the plurality of samples using a loudness neural network associated with the identified task that is occurring in the conversation. The samples can be processed to identify a pitch result based on pitch values of the plurality of samples using a pitch neural network associated with the identified task that is occurring in the conversation. The samples can be processed to identify a tone result for a plurality of words in the transcribed caller utterance using a tone neural network associated with the identified task that is occurring in the conversation. The characteristics of the conversation or the probability of characteristics of the conversation can be determined using the neural network (generative AI engine) associated with the conversation. An emotional state neural network can receive the loudness result, the pitch result, the tone result, or combinations thereof to determine an emotional state of the patient and determine whether to intervene. The present system can use systems and methods from U.S. Pat. No. 11,031,013 and U.S. patent application Ser. No. 18/388,042, which are both assigned to the present assignee and incorporated herein by reference.

FIG. 8 illustrates the pharmacy fulfillment device 234 according to an example implementation. The pharmacy fulfillment device 234 may be used to process and fulfill prescriptions and prescription orders as described above with respect to FIG. 1.

Specifically, ML models 114 determine if characteristics of conversations indicate that a number of customers above a threshold are going to order a particular medication. If so, the ML models 114 may initiate an automated fulfillment process to pre-emptively sort the particular medications into predefined amounts that are available to be sent to customers with little latency. After fulfillment, the fulfilled prescriptions are packed for shipping and upon formal ordering by the customers.

The pharmacy fulfillment device 234 may include devices in communication with ML models 114, a benefit manager device, an order processing device, and/or the storage device, directly or over a network. Specifically, the pharmacy fulfillment device 234 may include pallet sizing and pucking device(s) 206, loading device(s) 208, inspect device(s) 210, unit of use device(s) 212, automated dispensing device(s) 214, manual fulfillment device(s) 216, review devices 218, imaging device(s) 220, cap device(s) 222, accumulation devices 224, packing device(s) 226, literature device(s) 228, unit of use packing device(s) 230, and mail manifest device(s) 232. Further, the pharmacy fulfillment device 234 may include additional devices, which may communicate with each other directly or over a network.

In some implementations, operations performed by one of these devices 206-232 may be performed sequentially, or in parallel with the operations of another device as may be coordinated by the order processing device. In some implementations, the order processing device tracks a prescription with the pharmacy based on operations performed by one or more of the devices 206-232.

In some implementations, the pharmacy fulfillment device 234 may transport prescription drug containers, for example, among the devices 206-232 in the high-volume fulfillment center, by use of pallets. The pallet sizing and pucking device 206 may configure pucks in a pallet. A pallet may be a transport structure for a number of prescription containers, and may include a number of cavities. A puck may be placed in one or more than one of the cavities in a pallet by the pallet sizing and pucking device 206. The puck may include a receptacle sized and shaped to receive a prescription container. Such containers may be supported by the pucks during carriage in the pallet. Different pucks may have differently sized and shaped receptacles to accommodate containers of differing sizes, as may be appropriate for different prescriptions. For example, when the ML models 114 determine that number of prescriptions associated with a particular medication will be/have been requested based on the conversations (e.g., chats, transcripts of calls and/or emails), the pharmacy fulfillment device 234 may control the pallet sizing and pucking device 206 to construct and/or move pucks for fulfilling the particular medications.

The arrangement of pucks in a pallet may be determined by the order processing device based on prescriptions that the order processing device decides to launch. The arrangement logic may be implemented directly in the pallet sizing and pucking device 206. Once a prescription is set to be launched, a puck suitable for the appropriate size of container for that prescription may be positioned in a pallet by a robotic arm or pickers. The pallet sizing and pucking device 206 may launch a pallet once pucks have been configured in the pallet.

The loading device 208 may load prescription containers into the pucks on a pallet by a robotic arm, a pick and place mechanism (also referred to as pickers), etc. The ML models 114 may inform the pharmacy fulfillment device 234 that the particular medication will be ordered, and the pharmacy fulfillment device 234 may load prescription containers of the particular medication into the pucks to fulfill the orders of the particular medication. In various implementations, the loading device 208 has robotic arms or pickers to grasp a prescription container and move it to and from a pallet or a puck. The loading device 208 may also print a label that is appropriate for a container that is to be loaded onto the pallet, and apply the label to the container. The pallet may be located on a conveyor assembly during these operations (e.g., at the high-volume fulfillment center, etc.).

The inspect device 210 may verify that containers in a pallet are correctly labeled and in the correct spot on the pallet. The inspect device 210 may scan the label on one or more containers on the pallet. Labels of containers may be scanned or imaged in full or in part by the inspect device 210. Such imaging may occur after the container has been lifted out of its puck by a robotic arm, picker, etc., or may be otherwise scanned or imaged while retained in the puck. In some implementations, images and/or video captured by the inspect device 210 may be stored in the storage device as order data.

The unit of use device 212 may temporarily store, monitor, label, and/or dispense unit of use products to fulfill the orders for the particular medication. In general, unit of use products are prescription drug products that may be delivered to a user or member without being repackaged at the pharmacy. These products may include pills in a container, pills in a blister pack, inhalers, etc. Prescription drug products dispensed by the unit of use device 212 may be packaged individually or collectively for shipping, or may be shipped in combination with other prescription drugs dispensed by other devices in the high-volume fulfillment center.

At least some of the operations of the devices 206-232 may be directed by the order processing device 320. For example, the manual fulfillment device 216, the review device 218, the automated dispensing device 214, and/or the packing device 226, etc. may receive instructions provided by the order processing device 320.

The automated dispensing device 214 may include one or more devices that dispense prescription drugs or pharmaceuticals into prescription containers in accordance with one or multiple prescription orders to fulfill the orders of the particular medication. In general, the automated dispensing device 214 may include mechanical and electronic components with, in some implementations, software and/or logic to facilitate pharmaceutical dispensing that would otherwise be performed in a manual fashion by a pharmacist and/or pharmacist technician. For example, the automated dispensing device 214 may include high-volume fillers that fill a number of prescription drug types at a rapid rate and blister pack machines that dispense and pack drugs into a blister pack. Prescription drugs dispensed by the automated dispensing devices 214 may be packaged individually or collectively for shipping, or may be shipped in combination with other prescription drugs dispensed by other devices in the high-volume fulfillment center.

The manual fulfillment device 216 controls how prescriptions are manually fulfilled. For example, the manual fulfillment device 216 may receive or obtain a container and enable fulfillment of the container by a pharmacist or pharmacy technician. In some implementations, the manual fulfillment device 216 provides the filled container to another device in the pharmacy fulfillment devices to be joined with other containers in a prescription order for a user or member. In some cases, the manual fulfillment device 216 may operate based on data (anticipated prescription refills) from the ML models 114.

In general, manual fulfillment may include operations at least partially performed by a pharmacist or a pharmacy technician. For example, a person may retrieve a supply of the prescribed drug, may make an observation, may count out a prescribed quantity of drugs and place them into a prescription container, etc. Some portions of the manual fulfillment process may be automated by use of a machine. For example, counting of capsules, tablets, or pills may be at least partially automated (such as through use of a pill counter). Prescription drugs dispensed by the manual fulfillment device 216 may be packaged individually or collectively for shipping, or may be shipped in combination with other prescription drugs dispensed by other devices in the high-volume fulfillment center.

The review device 218 may process prescription containers to be reviewed by a pharmacist for proper pill count, exception handling, prescription verification, etc. Fulfilled prescriptions may be manually reviewed and/or verified by a pharmacist, as may be required by state or local law. A pharmacist or other licensed pharmacy person who may dispense certain drugs in compliance with local and/or other laws may operate the review device 218 and visually inspect a prescription container that has been filled with a prescription drug. The pharmacist may review, verify, and/or evaluate drug quantity, drug strength, and/or drug interaction concerns, or otherwise perform pharmacist services. The pharmacist may also handle containers which have been flagged as an exception, such as containers with unreadable labels, containers for which the associated prescription order has been canceled, containers with defects, etc. In an example, the manual review can be performed at a manual review station. In some examples, the review device 218 may review the prescription containers when a formal order is received for the prescription. Notably, the prescription containers may be filled prior to the formal order being received and based on the ML models 114 outputs.

The imaging device 220 may image containers once they have been filled with pharmaceuticals. The imaging device 220 may measure a fill height of the pharmaceuticals in the container based on the obtained image to determine if the container is filled to the correct height given the type of pharmaceutical and the number of pills in the prescription. Images of the pills in the container may also be obtained to detect the size of the pills themselves and markings thereon. The images may be transmitted to the order processing device and/or stored in the storage device as part of the order data.

The cap device 222 may be used to cap or otherwise seal a prescription container. In some implementations, the cap device 222 may secure a prescription container with a type of cap in accordance with a user preference (e.g., a preference regarding child resistance, etc.), a plan sponsor preference, a prescriber preference, etc. The cap device 222 may also etch a message into the cap, although this process may be performed by a subsequent device in the high-volume fulfillment center.

The accumulation device 224 accumulates various containers of prescription drugs in a prescription order. The accumulation device 224 may accumulate prescription containers from various devices or areas of the pharmacy. For example, the accumulation device 224 may accumulate prescription containers from the unit of use device 212, the automated dispensing device 214, the manual fulfillment device 216, and the review device 218. The accumulation device 224 may be used to group the prescription containers prior to shipment to the member.

The literature device 228 prints, or otherwise generates, literature to include with each prescription drug order. The literature may be printed on multiple sheets of substrates, such as paper, coated paper, printable polymers, or combinations of the above substrates. The literature printed by the literature device 228 may include information required to accompany the prescription drugs included in a prescription order, other information related to prescription drugs in the order, financial information associated with the order (for example, an invoice or an account statement), etc.

In some implementations, the literature device 228 folds or otherwise prepares the literature for inclusion with a prescription drug order (e.g., in a shipping container). In other implementations, the literature device 228 prints the literature and is separate from another device that prepares the printed literature for inclusion with a prescription order.

The packing device 226 packages the prescription order in preparation for shipping the order. The packing device 226 may box, bag, or otherwise package the fulfilled prescription order for delivery. The packing device 226 may further place inserts (e.g., literature or other papers, etc.) into the packaging received from the literature device 228. For example, bulk prescription orders may be shipped in a box, while other prescription orders may be shipped in a bag, which may be a wrap seal bag.

The packing device 226 may label the box or bag with an address and a recipient's name. The label may be printed and affixed to the bag or box, be printed directly onto the bag or box, or otherwise associated with the bag or box. The packing device 226 may sort the box or bag for mailing in an efficient manner (e.g., sort by delivery address, etc.). The packing device 226 may include ice or temperature sensitive elements for prescriptions that are to be kept within a temperature range during shipping (for example, this may be necessary in order to retain efficacy). The ultimate package may then be shipped through postal mail, through a mail order delivery service that ships via ground and/or air (e.g., UPS, FEDEX, or DHL, etc.), through a delivery service, through a locker box at a shipping site (e.g., AMAZON locker or a PO Box, etc.), or otherwise.

The unit of use packing device 230 packages a unit of use prescription order in preparation for shipping the order. The unit of use packing device 230 may include manual scanning of containers to be bagged for shipping to verify each container in the order. In an example implementation, the manual scanning may be performed at a manual scanning station. The pharmacy fulfillment device 234 may also include a mail manifest device 232 to print mailing labels used by the packing device 226 and may print shipping manifests and packing lists.

While the pharmacy fulfillment device 234 in FIG. 8 is shown to include single devices 206-232, multiple devices may be used. When multiple devices are present, the multiple devices may be of the same device type or models, or may be a different device type or model. The types of devices 206-232 shown in FIG. 8 are example devices. In other configurations of the pharmacy fulfillment device 234, lesser, additional, or different types of devices may be included.

Moreover, multiple devices may share processing and/or memory resources. The devices 206-232 may be located in the same area or in different locations. For example, the devices 206-232 may be located in a building or set of adjoining buildings. The devices 206-232 may be interconnected (such as by conveyors), networked, and/or otherwise in contact with one another or integrated with one another (e.g., at the high-volume fulfillment center, etc.). In addition, the functionality of a device may be split among a number of discrete devices and/or combined with other devices.

FIG. 9 illustrates the order processing device 320 according to an example implementation and be readily incorporated into the above pharmacy fulfillment device 234 (FIG. 8). The order processing device 320 may be used by one or more operators to generate prescription orders, make routing decisions, make prescription order consolidation decisions, track literature, and/or view order status and other order related information. For example, the prescription order may include order components.

The order processing device 320 may receive instructions to fulfill an order without operator intervention (e.g., based on characteristic identification noted above and when a certain amount of requests meets a threshold as identified by ML models 114). An order component may include a prescription drug fulfilled by use of a container. The order processing device 320 may include an order verification subsystem 322, an order control subsystem 324, and/or an order tracking subsystem 326. Other subsystems may also be included in the order processing device 320.

The order verification subsystem 322 may communicate with a benefit manager device to verify the eligibility of the member and review the formulary to determine appropriate copayment, coinsurance, and deductible for the prescription drug and/or perform a DUR (drug utilization review). Other communications between the order verification subsystem 322 and the benefit manager device may be performed for a variety of purposes.

The order control subsystem 324 controls various movements of the containers and/or pallets along with various filling functions during their progression through a fulfillment system. In some implementations, the order control subsystem 324 may identify the prescribed drug in one or more than one prescription orders as capable of being fulfilled by the automated dispensing device 214. The order control subsystem 324 may determine which prescriptions are to be launched and may determine that a pallet of automated-fill containers is to be launched.

The order control subsystem 324 may determine that an automated-fill prescription of a specific pharmaceutical is to be launched and may examine a queue of orders awaiting fulfillment for other prescription orders, which will be filled with the same pharmaceutical. The order control subsystem 324 may then launch orders with similar automated-fill pharmaceutical needs together in a pallet to the automated dispensing device 214. As the devices 206-232 may be interconnected by a system of conveyors or other container movement systems, the order control subsystem 324 may control various conveyors: for example, to deliver the pallet from the loading device 208 to the manual fulfillment device 216 from the literature device 228, paperwork as needed to fill the prescription.

The order tracking subsystem 326 may track a prescription order during its progress toward fulfillment. The order tracking subsystem 326 may track, record, and/or update order history, order status, etc. The order tracking subsystem 326 may store data locally (for example, in a memory) or as a portion of the order data stored in the storage device.

“COMPONENT” in this context refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

A hardware component may also be implemented mechanically, electronically, or any suitable combination thereof. For example, a hardware component may include dedicated circuitry or logic that is permanently configured to perform certain operations. A hardware component may be a special-purpose processor, such as a Field-Programmable

Gate Array (FPGA) or an ASIC. A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output.

Hardware components may also initiate communications with input or output devices and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

The term “coupled” can be used herein to refer to any type of relationship, direct or indirect, between the components in question, and can apply to electrical, mechanical, fluid, optical, electromagnetic, electromechanical or other connections. In addition, the terms “first”, “second”, etc. can be used herein only to facilitate discussion, and carry no particular temporal or chronological significance unless otherwise indicated.

Those skilled in the art will appreciate from the foregoing description that the broad techniques of the embodiments of the present disclosure can be implemented in a variety of forms. Therefore, while the embodiments of this disclosure have been described in connection with particular examples thereof, the true scope of the embodiments of the disclosure should not be so limited since other modifications will become apparent to the skilled practitioner upon a study of the drawings, specification, and following claims.

We claim:

1. A computing system comprising:
a processor; and
a memory having a set of instructions, which when executed by the processor, cause the computing system to:
classify a communication session into a first category of a plurality of categories;
identify a selected model from a plurality of models based on the communication session being classified into the first category, wherein the selected model includes neurons that include adjustable weight parameters, and the selected model is configured to process communication data of the communication session with the neurons, wherein the weight parameters modify values of the neurons; and
determine, with the selected model, a characteristic of the communication session.

2. The computing system of claim 1, wherein the instructions of the memory, when executed, cause the computing system to:
adjust a parameter of the communication session based on the characteristic; and
present the characteristic on a graphical user interface.

3. The computing system of claim 1, wherein the instructions of the memory, when executed, cause the computing system to:
schedule a remediation action based on the characteristic.

4. The computing system of claim 1, wherein the plurality of models include:
a first plurality of machine learning models that are dedicated to determining chat characteristics of chat conversations;
a second plurality of machine learning models that are dedicated to determining call characteristics of call conversations; and
a third plurality of machine learning models that are dedicated to determining email characteristics of emails,
wherein the selected model includes the first plurality of machine learning models, the second plurality of machine learning models or the third plurality of machine learning models.

5. The computing system of claim 1, wherein:
the first category is a chat category; and
the characteristic includes one or more of a topic, a sub-topic, a sentiment, whether a chat of the communication session is dropped, a reason for the chat being dropped if the chat is dropped, whether a chat agent contacted a third-party, whether a callback number was provided, or a name.

6. The computing system of claim 1, wherein:
the first category is a call category; and
the characteristic includes one or more of a topic, a sentiment, a sub-topic, a name, whether a call of the communication session was transferred, whether the call was resolved, whether the call is associated with multiple users, or a name.

7. The computing system of claim 1, wherein:
the first category is an email category; and
the characteristic includes one or more of a topic, a sentiment, a sub-topic, a name, or a signature.

8. At least one non-transitory computer readable storage medium comprising a set of instructions, which when executed by a computing system, cause the computing system to:
classify a communication session into a first category of a plurality of categories;
identify a selected model from a plurality of models based on the communication session being classified into the first category, wherein the selected model includes neurons that include adjustable weight parameters, and the selected model is configured to process communication data of the communication session with the neurons, wherein the weight parameters modify values of the neurons; and
determine, with the selected model, a characteristic of the communication session.

9. The at least one non-transitory computer readable storage medium of claim 8, wherein the instructions, when executed, cause the computing system to:
adjust a parameter of the communication session based on the characteristic; and
present the characteristic on a graphical user interface.

10. The at least one non-transitory computer readable storage medium of claim 8, wherein the instructions, when executed, cause the computing system to:
schedule a remediation action based on the characteristic.

11. The at least one non-transitory computer readable storage medium of claim 8, wherein the plurality of models include:
a first plurality of machine learning models that are dedicated to determining chat characteristics of chat conversations;
a second plurality of machine learning models that are dedicated to determining call characteristics of call conversations; and
a third plurality of machine learning models that are dedicated to determining email characteristics of emails,
wherein the selected model includes the first plurality of machine learning models, the second plurality of machine learning models or the third plurality of machine learning models.

12. The at least one non-transitory computer readable storage medium of claim 8, wherein:
the first category is a chat category; and
the characteristic includes one or more of a topic, a sub-topic, a sentiment, whether a chat of the communication session is dropped, a reason for the chat being dropped if the chat is dropped, whether a chat agent contacted a third-party, whether a callback number was provided, or a name.

13. The at least one non-transitory computer readable storage medium of claim 8, wherein:
the first category is a call category; and
the characteristic includes one or more of a topic, a sentiment, a sub-topic, a name, whether a call of the communication session was transferred, whether the call was resolved, whether the call is associated with multiple users, or a name.

14. The at least one non-transitory computer readable storage medium of claim 8, wherein:
the first category is an email category; and
the characteristic includes one or more of a topic, a sentiment, a sub-topic, a name, or a signature.

15. A method comprising:
classifying a communication session into a first category of a plurality of categories;
identifying a selected model from a plurality of models based on the communication session being classified into the first category, wherein the selected model includes neurons that include adjustable weight parameters, and the selected model is configured to process communication data of the communication session with the neurons, wherein the weight parameters modify values of the neurons; and
determining, with the selected model, a characteristic of the communication session.

16. The method of claim 15, further comprising:
adjusting a parameter of the communication session based on the characteristic; and
presenting the characteristic on a graphical user interface.

17. The method of claim 15, further comprising:
scheduling a remediation action based on the characteristic.

18. The method of claim 15, wherein the plurality of models include:
a first plurality of machine learning models that are dedicated to determining chat characteristics of chat conversations;
a second plurality of machine learning models that are dedicated to determining call characteristics of call conversations; and
a third plurality of machine learning models that are dedicated to determining email characteristics of emails,
wherein the selected model includes the first plurality of machine learning models, the second plurality of machine learning models or the third plurality of machine learning models.

19. The method of claim 15, wherein:
the first category is a chat category; and
the characteristic includes one or more of a topic, a sub-topic, a sentiment, whether a chat of the communication session is dropped, a reason for the chat being dropped if the chat is dropped, whether a chat agent contacted a third-party, whether a callback number was provided, or a name.

20. The method of claim 15, wherein:
the first category is a call category; and
the characteristic includes one or more of a topic, a sentiment, a sub-topic, a name, whether a call of the communication session was transferred, whether the call was resolved, whether the call is associated with multiple users, or a name.
